(19) United States
(12) Patent Application Publication
(10) Pub. No.: US 2021/0059208 A1
(43) Pub. Date: Mar. 4, 2021

(54) ENCLOSED CAT LITTER BOX WITH LITTER REMOVING PERIMETER WALKWAY

(71) Applicant: Isaac Ricketts, Eagle, ID (US)

(72) Inventor: Isaac Ricketts, Eagle, ID (US)

(21) Appl. No.: 16/555,240

(22) Filed: Aug. 29, 2019

(51) Int. Cl. A01K 1/01

(52) U.S. Cl. CPC A01K 1/0107

(57) ABSTRACT

What is disclosed is a litter box having a walkway on which an animal is forced to walk to get to of or into the litter. The litter box has a tray that is configured to hold litter. The tray has a base that is defined by a perimeter wall extending upward from the tray. The walkway is a grate walkway and positioned above the litter such that any litter on the animal's feet falls through the walkway and back to the litter. The walkway extends around the perimeter of the litter box to maximize the distance on which the animal must walk to enter or leave the litter box. An inner wall of the walkway defines a cavity in the litter box into which the animal jumps or steps from the walkway and to the walkway from the litter.

### TECHNICAL FIELD

The presently disclosed technology relates generally to sanitary facilities for animals, and more particularly to a litter box particularly adapted for use by small animals such as house cats.

### BACKGROUND OF THE INVENTION

Litterboxes have regularly been used for animal feces and urine collection for animals such as cats, dogs, rabbits, ferrets, miniature pigs, and other pets that instinctively or through training will make use of the litter box. Litter boxes allow animals that do not have access to the outdoors to excrete their waste indoors in a collected area.

The bottom of a litter box is typically filled with litter, which is a loose, granular material that absorbs moisture and odors such as ammonia. Litter sometimes contains additional materials such as baking soda to absorb such odors. The most common type of litter uses clay, although silica-based crystal variants and recycled paper are also be used. Litter is removed from the litter box and discarded in order to maintain a healthy litter box environment for the animals indoors.

A common problem that many litter box owners encounter, is that the litter will often stick to the bottoms of the animal's feet or paws. As a result, the animal will often track the litter from the litter box throughout the indoors. What is needed is a device that provides a track with sufficient length will catch a majority, if not all of, the litter from the animal's feet and allow it to return to the litter box.

### SUMMARY OF THE INVENTION

The purpose of the summary is to enable the public, and especially the scientists, engineers, and practitioners in the art who are not familiar with patent or legal terms or phraseology, to determine quickly from a cursory inspection, the nature and essence of the technical disclosure of the application. The summary is neither intended to define the inventive concept(s) of the application, which is measured by the claims, nor is it intended to be limiting as to the scope of the inventive concept(s) in any way.

What is disclosed herein is a litter box. The litter box has a base, an upper housing and a walkway. The base is preferably a tray having a perimeter wall extending upward from the tray to retain litter, forming a basin. The upper housing has an perimeter wall and is covered by a top portion. An inner wall is positioned proximate to the interior perimeter of the walkway.

The upper housing is configured to be integral with the base. Alternatively, the upper housing is removably attached to the base. The removable attachment can be, but not limited to, clamps, latches, snap-on attachment, threading, a recess in the litter box base that provides a force-fit to secure the upper housing, or being engaged on top of the litter box base by gravity or atmospheric pressure.

The top portion is preferably integral with the perimeter wall and the inner wall to form a singular piece. In alternate embodiments the top portion can be removably attached to the perimeter wall and inner wall. In another alternate embodiment the top portion is not attached to the inner wall.

A walkway is positioned within the litter box and above the basin. The walkway extends the length of the perimeter of the litter box. This shape forces the animal to walk the entire length of the walkway before it can exit the litter box. The walkway is a grate configured to allow litter stuck to the animal's feet to pass through and fall into the litter box base before the animal exits the litter box. The walkway can be made from a hard durable material, such as metal or plastic, or a mesh fabric material. The walkway is configured to attach to the base or the upper housing or both. The walkway can be fixed in integral to the litter box or removable to the litter box.

The walkway can be configured to attach to the upper housing in a variety of embodiments. The walkway can be integral to the inner wall and to the perimeter wall. The walkway can also be removably attached to either the inner wall, the perimeter wall or both. The walkway can be positioned within the litter box base or on top of or proximate to the edges of the litter box base.

The perimeter wall has an exterior opening configured for entry of an animal to the walkway. The inner wall has an interior opening configured for entry of an animal from the walkway to the base of the litter box where the litter is located. A divider is positioned proximate to the interior opening and the exterior opening. The divider is configured to prevent an animal entering the litter box from entering the exterior opening and directly entering the interior opening. The divider, exterior opening, and interior opening are configured so that an animal accessing the contents of the litter box base will walk the length of the walkway to get to and leave the litter.

The exterior opening and interior opening are preferably offset with the divider positioned between them. Alternatively, the interior opening and exterior opening can overlap or align and the divider is positioned angularly proximate to the interior opening and the exterior opening.

The litter box is preferably spherical in shape. Alternatively, the litter box is ellipsoidal or other shape such as a cuboid or a rectangular prism.

In alternate embodiments, a sifting tray or an automatic cleaning device can be placed within the litter box base.

Still other features and advantages of the claimed invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the description of the preferred embodiments is to be regarded as illustrative in nature, and not as restrictive in nature.

### BRIEF DESCRIPTION OF THE DRAWINGS

FIG. 1 is a side perspective view of a preferred embodiment of a litter box.

FIG. 2 is an exploded view of a preferred embodiment of a litter box.

FIG. 3 is an exploded view of an embodiment of a litter box.

FIG. 4 is an exploded view of an embodiment of a litter box.

FIG. 5 is a top perspective view of a preferred embodiment a litter box.

FIG. 6 a top view of the path of a preferred embodiment of a litter box.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

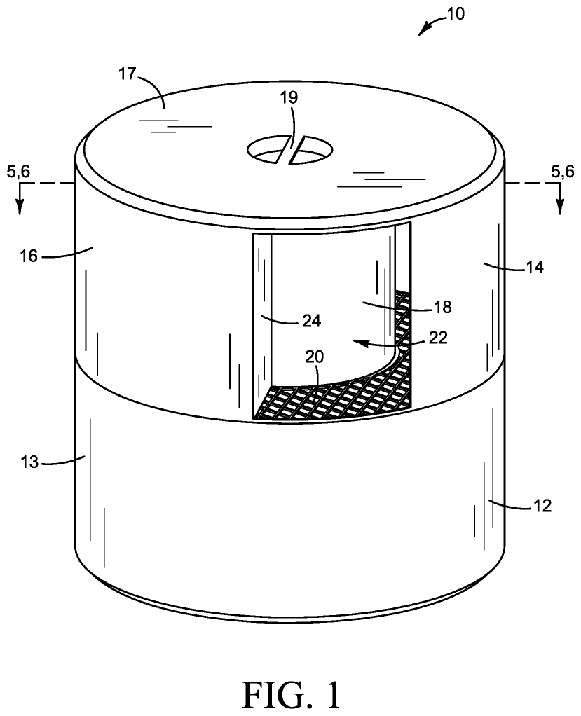

FIG. 1 illustrates a preferred embodiment of the litter box 10. In a preferred embodiment, the litter box 10 has a litter box base 12 and an upper housing 14.

In a preferred embodiment, the upper housing 14 is configured to attach to the litter box base 12. This attachment can be made in a variety of ways, including but not limited to clamps, latches, snap-on attachment, threading, or engaging on top of the litter box base by gravity or atmospheric pressure. In an alternate embodiment, the upper housing 14 can be integral to the litter box base 12. In a further alternate embodiment, the litter box base 12 has a recess in its perimeter 13 and the upper housing is received in the recess of the litter box base in a force-fit to secure the upper housing on the litter box base.

Illustrated in FIG. 1, the upper housing has an perimeter wall 16. A walkway 20 preferably extends between the perimeter wall 16 and the inner wall 18. In a preferred embodiment, the walkway 20 is a grate and can be composed of a variety of materials that can support the weight of an animal such as plastic, metal, mesh netting, or a woven durable material.

FIG. 1 also illustrates a preferred embodiment of an exterior opening 22 on the perimeter wall 18. Preferably positioned proximate to the exterior opening 22 is a divider 24 that is positioned between the perimeter wall 16 and the inner wall 18.

In a preferred embodiment, the upper housing 14 has a housing top 17 with a handle 19. In a preferred embodiment the housing top 17 is integral with the inner wall 18 and the perimeter wall 16. In an alternate embodiment the upper housing top 17 can be removably attached to the perimeter wall 16, the inner wall 18, or both the perimeter wall 16 and the inner wall 18. In alternative embodiments, the housing top 17 or perimeter wall 16 include features such as air vents and recesses for air filters and air deodorizers.

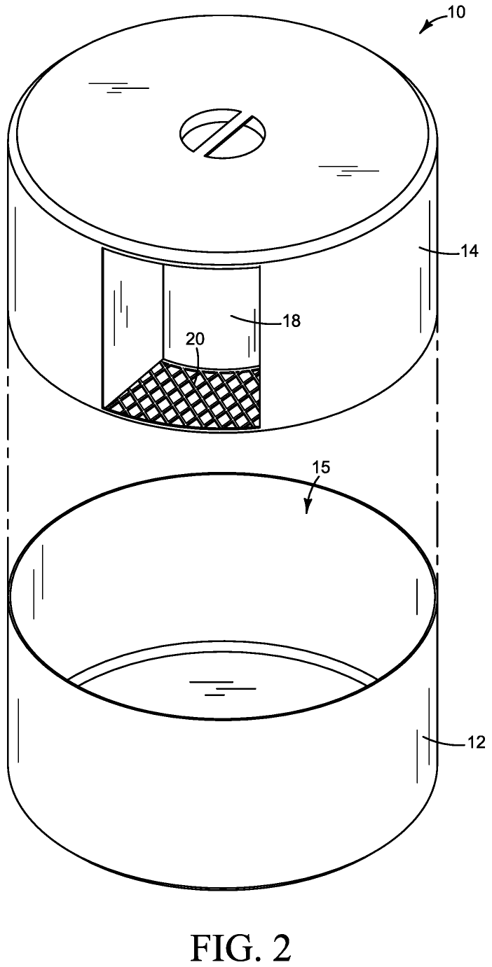

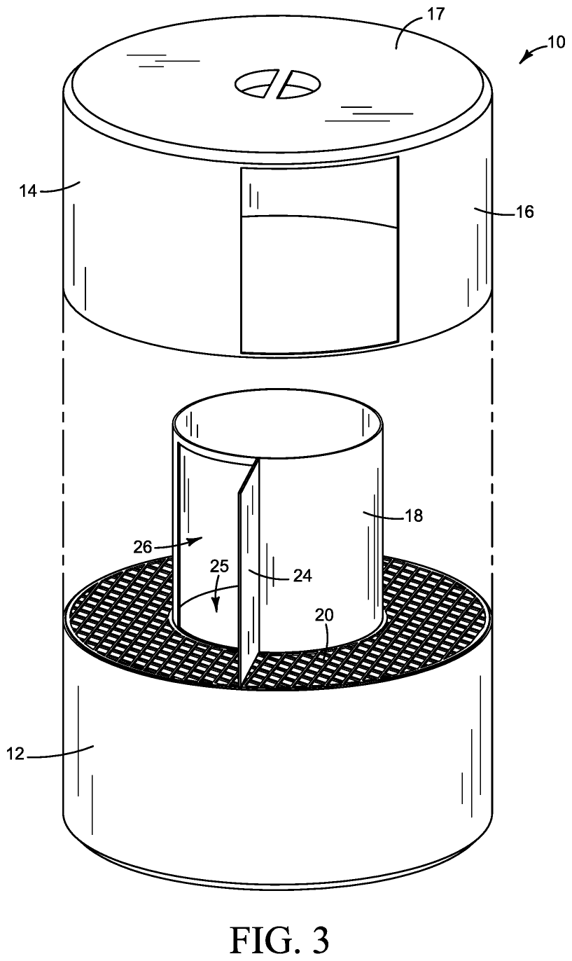

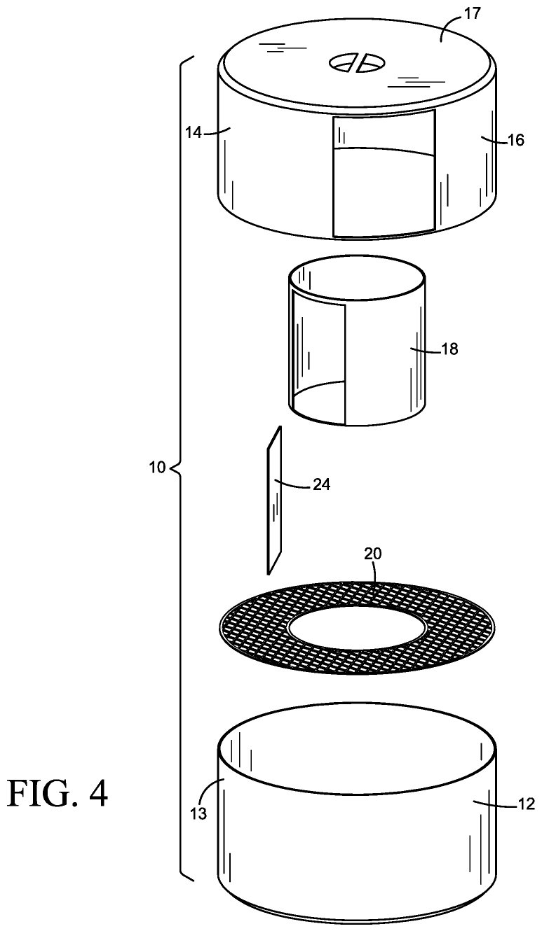

FIG. 2 illustrates a preferred embodiment of the litter box 10 with the upper housing 14 removed from the litter box base 12. The walkway 20 is preferably integral with the inner wall 18 and the perimeter wall 16. In alternate embodiments, the walkway 20 is removably attached to either the inner wall 18, the perimeter wall 16 (FIG. 3), or both the perimeter wall 16 and the inner wall 18 (FIG. 4).

The basin 15 of the litter box base 12 is preferably devoid of structures in order to be filled with litter. In alternate embodiments, the litter box base can include structures such as self-cleaning mechanism or a sifting tray.

FIG. 3 illustrates an embodiment of the litter box 10. The walkway 20 is integral with the inner wall 18 and removably attached the perimeter wall 16. The housing top 17 and perimeter wall 16 removably attach to the litter box base 12.

FIG. 3 illustrates a preferred embodiment of the interior opening 26. In a preferred embodiment, the divider 24 is fixedly attached proximate to the interior opening 26. The interior opening 26 is preferably offset in position from the exterior opening 22 and the divider 24 is positioned radially.

In the embodiment illustrated in FIG. 3, the divider 24 is fixedly attached to the inner wall 18 and removably attached to the perimeter wall 16 when the perimeter wall 16 is removably attached to the perimeter walkway. The divider 24 is positioned proximate to the interior opening 26 and the exterior opening 22 in order for the animal entering the litter box 10 to traverse the entirety of the walkway 20.

In an alternate embodiment, the interior opening 26 is aligned with the exterior opening 22. Alternatively, the interior opening 26 and the exterior opening 22 partially overlap. In these alternative embodiments, divider 24 is angularly positioned proximate to the interior opening 26 and the exterior opening 22.

In a preferred embodiment, the walkway 20 defines an opening 25 that allows for an animal to enter the contents of the basin 15. The opening 25 preferably does not extend within the perimeter of the inner wall 18.

FIG. 4 illustrates an embodiment of the litter box 10 with the components being removably attachable. In this embodiment, the perimeter wall 16 is attached to the housing top 17. In an alternate embodiment, the housing top 17 is removably attached to the perimeter wall 16.

In the embodiment illustrated in FIG. 4, the divider 24 is removably attached to the perimeter wall 16 and the inner wall 18, preferably by a slideable attachment. The inner wall 18 is removably attached to the walkway 20. The inner wall 18 attaches to the top portion 17 by engaging against the top portion 17 or by a recess in the top portion 17 that creates force-fit to secure the top portion 17 to the inner wall 18.

The walkway 20 attaches on above the basin. In an alternate embodiment the walkway 20 inserts within the perimeter 13 or proximate to the perimeter 13.

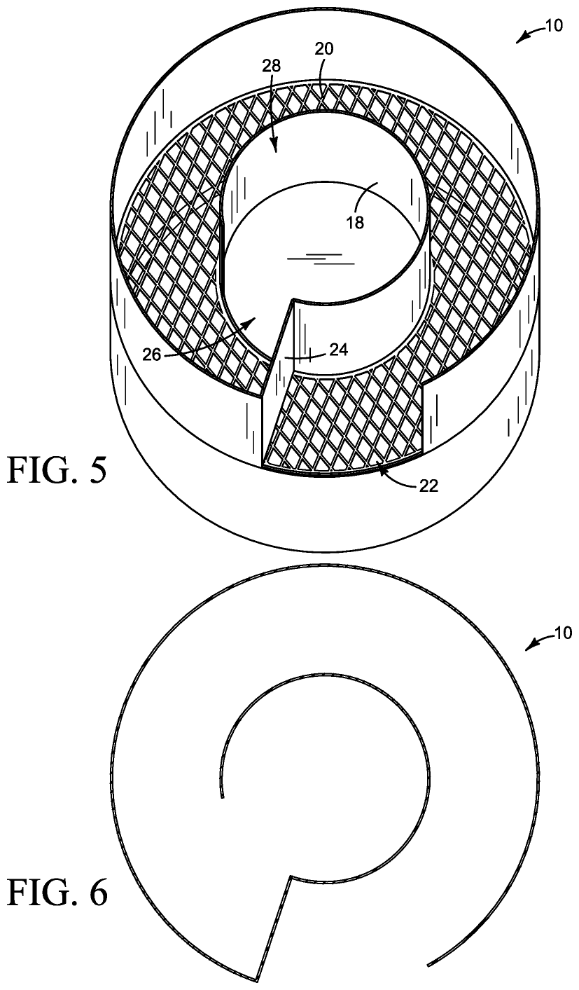

FIG. 5 illustrates an embodiment of the litter box 10 with the top portion (not illustrated) removed. In a preferred embodiment, the interior opening 26 is positioned offset from the exterior opening 22. The divider 24 is positioned proximate to the interior opening 26 and to the exterior opening 22. The divider 24 is configured to prevent an animal from entering the exterior opening 22 and directly entering the interior opening 26, forcing the animal to traverse the distance of the walkway 20. The walkway 20 preferably extends from the perimeter wall 16 to the inner wall 18. The walkway 20 preferably does not extend within the perimeter of the inner wall 18.

In a preferred embodiment, the inner wall 18 defines a chamber 28 that an animal can access via the interior opening 26. The chamber 28 allows for the animal to access the contents of the litter box base 12.

FIG. 6 illustrates the preferred shape of the litter box 10. In a preferred embodiment, the litter box 10 is preferably circular. In an alternate embodiment, litter box can be an ellipsoidal or a geometric shape with at least three sides.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

What is claimed is:

1. A litter box comprising:
a container comprising a perimeter wall extending the perimeter of said, a top, and defining a basin configured for retaining litter;
a walkway positioned above said basin and configured for a small animal to walk on a length of said walkway, wherein said walkway comprises an inner wall on a first side of said walkway and is defined by said perimeter wall on a second side of said walkway, wherein said inner wall defines a cavity extending generally from said top extending to said basin, wherein said walkway comprises a grate configured for litter to fall through said grate;
a divider positioned on said walkway and configured to provide a first end to said walkway and a second end to said walkway;
an exterior opening, wherein said exterior opening is located in said perimeter wall proximate to said first end of said walkway and configured for the ingress and egress of a small animal onto said track from outside of said container;
an interior opening, wherein said interior opening is located proximate to said second side of said divider, wherein said internal opening is configured for the ingress and egress of a small animal between said track and said cavity.

2. The litter box of claim 1 wherein said perimeter wall comprises an upper section and a lower section, wherein said upper section comprises said top and said lower section comprises said basin, wherein said upper section and said lower section are configured to open.

3. The litter box of claim 1, wherein said perimeter wall comprises a generally round shape.

4. The litter box of claim 2 wherein said walkway is integral with said upper section.

5. The litter box of claim 2, wherein said walkway is attached to said lower section.

6. The litter box of claim 2, wherein said walkway is configured for placement on top of said lower section of said perimeter wall, wherein said upper section is configured for placement on top of said walkway.

7. The litter box of claim 1, wherein said divider is integral with said inner wall.

8. The litter box of claim 9, wherein said divider is integral with said outer wall.

9. The litter box of claim 1, wherein said container comprises a cylindrical shape, wherein said walkway comprises a ring shape.

10. A litter box comprising:
a tray, said tray comprising a bottom wall and a tray perimeter wall, said tray defining a basin;
an upper housing, said upper housing comprising an perimeter wall and a top, wherein said upper housing is configured to cover said tray, wherein said upper housing is configured to be removably attached to said tray perimeter wall;
a walkway positioned above said basin and configured for a small animal to walk on a length of said walkway, wherein said walkway comprises a grate configured for litter to fall through said grate, wherein, said walkway is defined by said perimeter wall on an exterior side of said walkway;
an inner wall attached on an interior side of said walkway, wherein said inner wall defines a cavity extending generally from said top to said basin;
a divider positioned on said walkway and configured to provide a first end to said walkway and a second end to said walkway;
an exterior opening, wherein said exterior opening is located in said perimeter wall proximate to said first end of said walkway and configured for the ingress and egress of a small animal onto said track from outside of said litter box;
an interior opening, wherein said interior opening is located in said inner wall proximate to said second end of said walkway and configured for the ingress and egress of a small animal between said walkway and said basin.
an exterior opening, wherein said exterior opening is located in said perimeter wall proximate to said first end of said walkway and configured for the ingress and egress of a small animal onto said track from outside of said container;
an interior opening, wherein said interior opening is located proximate to said second side of said divider, wherein said internal opening is configured for the ingress and egress of a small animal between said track and said cavity.

11. The litter box assembly of claim 10 wherein said walkway is configured to be removably attached from said upper housing.

12. The litter box of claim 11 wherein said walkway is configured to be removably attached from said tray.

13. The litter box of claim 10 wherein said inner wall is configured to be removably attached to said walkway.

14. The litter box of claim 10 wherein said inner wall is configured to be removably attached to said top.

15. The litter box assembly of claim 10 wherein said divider is slideably attached to said perimeter wall.

16. The litter box assembly of claim 16 wherein said divider is slideably attached to said inner wall.

17. A litter box comprising:
a tray, said tray comprising a bottom wall and a tray perimeter wall, said tray defining a basin;
an upper housing, said upper housing comprising an perimeter wall and a top, wherein said upper housing is configured to cover said tray, wherein said upper housing is configured to be removably attached to said tray perimeter wall;
a walkway positioned above said basin and configured for a small animal to walk on a length of said walkway, wherein said walkway comprises a grate configured for litter to fall through said grate, wherein, said walkway is defined by said perimeter wall on an exterior side of said walkway, wherein said walkway is removably attached to said perimeter wall;
an inner wall attached on an interior side of said walkway, wherein said inner wall defines a cavity extending generally from said top to said basin, wherein said inner wall is removably attached to said walkway, wherein said inner wall is removably attached to said top;
a divider positioned on said walkway and configured to provide a first end to said walkway and a second end to said walkway, wherein said divider is slideably attached to said inner wall and said divider is slideably attached to said perimeter wall;
an exterior opening, wherein said exterior opening is located in said perimeter wall proximate to said first end of said walkway and configured for the ingress and egress of a small animal onto said track from outside of said litter box;
an exterior opening, wherein said exterior opening is located in said perimeter wall proximate to said first end of said walkway and configured for the ingress and egress of a small animal onto said track from outside of said container;
an interior opening, wherein said interior opening is located proximate to said second side of said divider, wherein said internal opening is configured for the ingress and egress of a small animal between said track and said cavity.
